(19) United States
(12) Patent Application Publication
(10) Pub. No.: US 2006/0066763 A1
(43) Pub. Date: Mar. 30, 2006

(54) Projection-type display device

(76) Inventor: Kinya Ozawa, Suwa (JP)

Correspondence Address: HARNESS, DICKEY & PIERCE, P.L.C., P.O. BOX 828, BLOOMFIELD HILLS, MI, 48303, US

(21) Appl. No.: 11/218,162

(22) Filed: Sep. 1, 2005

(30) Foreign Application Priority Data
Sep. 29, 2004 (JP) 2004-284003

(51) Int. Cl. G02F 1/1335

(52) U.S. Cl. 349/5

(57) ABSTRACT

A projection-type display device includes an illumination unit, an optical modulation unit, and a projection lens that projects light modulated by the optical modulation unit. The optical modulation unit has a pair of substrates with a liquid crystal layer interposed therebetween, the liquid crystal layer showing negative dielectric anisotropy and an initial alignment thereof having a pretilt in an approximately vertical direction and a predetermined azimuth angle direction, a liquid crystal panel, in which light from the illumination unit is incident on one of the pair of substrates and light is emitted from the other substrate, and a polarizer and an analyzer that are disposed at an incident side and an emission side of the liquid crystal panel, respectively. An optical compensating plate has a liquid crystal layer, in which liquid crystal molecules showing negative refractive index anisotropy having in-plane uniaxial anisotropy are hybrid-aligned, between the liquid crystal panel and the polarizer or between the liquid crystal panel and the analyzer.

### BACKGROUND OF THE INVENTION

1. Technical Field

The present invention relates to a projection-type display device.

2. Related Art

Liquid crystal light valves are used as light modulation devices of projection-type display devices, such as a liquid crystal projector or the like. In the liquid crystal light valves, a liquid crystal layer is interposed between a pair of substrates. Electrodes to apply an electric field to the liquid crystal layer are formed inside the pair of substrates. Alignment films to control alignment states of liquid crystal molecules are formed inside the electrodes. Image light is formed on the basis of the variation in the alignment of the liquid crystal molecules at the time of the application of a non-selection voltage and at the time of the application of a selection voltage. In the projection-type display devices using the related art liquid crystal light valves, the contrast ratio of a projected image is at most 1:500, which is still smaller than the contrast ratio of 1:3000 in the projection-type display device using a mechanical shutter, such as a DMD (digital micromirror device) (Registered Trademark). This results from a viewing angle characteristic of the liquid crystal light valve. That is, light-source light which is incident on the liquid crystal light valve of the projection-type display device is not completely parallel light, but has a predetermined incident angle. The liquid crystal light valve has an incident angle dependency, which causes the reduction of the contrast ratio of the projected image.

Therefore, in order to compensate for the incident angle dependency of the liquid crystal light valve in the projection-type display device, an optical compensating plate is adopted (for example, see Japanese Unexamined Patent Application Publication No. 2004-29251). The optical compensating plate hybrid-aligned discotic liquid crystal showing negative refractive index anisotropy. The optical compensating plate is used to obtain a wide viewing angle in a direct-view-type liquid crystal display device. For example, in Japanese Patent No. 2866372, in particular, an optical compensating plate suitable for a liquid crystal display device of a vertical alignment mode is disclosed.

However, the optical compensating plate was originally developed for use in a direct-view-type liquid crystal display device, and is designed to obtain a high contrast ratio in a wide range of a viewing angle. On the contrary, the incident angle of light-source light to an optical modulation device of the projection-type display device is at most a polar angle of about 12°, and thus a projected image is formed by incident light having such a narrow angle range. Accordingly, a liquid crystal light valve capable of obtaining a higher contrast ratio in the narrow incident angle range is desirable.

On the other hand, the technology disclosed in Japanese Unexamined Patent Application Publication No. 2004-29251 is specifically directed to a reflection-type liquid crystal light valve, and cannot be applied to a transmission-type liquid crystal light valve as it is. In addition, in order to stably tilt the liquid crystal molecules of the liquid crystal light valve in a predetermined direction at the time of the application of the selection voltage and to generate disclination, a large pretilt angle, for example, an angle of 5° to 10° from the substrate normal direction, needs to be imparted. When such a large pretilt angle is imparted, sufficient contrast cannot be realized with the optical compensating plate used in Japanese Unexamined Patent Application Publication No. 2004-29251 or Japanese Patent No. 2866372.

### SUMMARY

An advantage of the invention is that it provides a projection-type display device that can obtain a higher contrast ratio in a range of an incident angle of light-source light with respect to an optical modulation device.

According to an aspect of the invention, a projection-type display device includes an illumination unit, an optical modulation unit, and a projection unit that projects light modulated by the optical modulation unit. The optical modulation unit has a pair of substrates with a liquid crystal layer interposed therebetween, the liquid crystal layer showing negative dielectric anisotropy and an initial alignment thereof having a pretilt in an approximately vertical direction and in a predetermined azimuth angle direction, a liquid crystal panel, in which light from the illumination unit is incident on one of the pair of substrates and light is emitted from the other substrate, and a polarizer and an analyzer that are disposed at an incident side and an emission side of the liquid crystal panel, respectively. An optical compensating plate has a liquid crystal layer, in which liquid crystal molecules showing negative refractive index anisotropy having in-plane uniaxial anisotropy are hybrid-aligned, between the liquid crystal panel and the polarizer or between the liquid crystal panel and the analyzer.

In accordance with the aspect of the invention, the liquid crystal panel constituting the optical modulation unit has the liquid crystal layer which shows negative dielectric anisotropy and of which the initial alignment has the pretilt in the approximately vertical direction and in the predetermined azimuth angle direction, that is, a liquid crystal layer of a vertical alignment mode having a given pretilt. Generally, when a pretilt is given to vertically aligned liquid crystal, in view of a curve showing equivalent contrast ratios, a high-contrast-ratio region is maldistributed from the substrate normal direction to the azimuth angle direction of the pretilt. The optical compensating plate has the liquid crystal layer between the liquid crystal panel having such a property, and the polarizer and the analyzer. In the liquid crystal layer, the liquid crystal molecules showing negative refractive index anisotropy having in-plane uniaxial anisotropy are hybrid-aligned. Therefore, the high-contrast-ratio region, which is maldistributed from the substrate normal direction, moves to the substrate normal direction. By doing so, with respect to light having a narrow incident angle range with the substrate normal direction as a center, a high contrast ratio can be obtained. The inventors have performed the simulation in order to verity advantages of the invention. These advantages will be described in ‘Description of the Embodiments’.

In the projection-type display device according to the aspect of the invention, it is preferable that a slow axis of the optical compensating plate is disposed at about 45° with respect to an azimuth angle direction of the pretilt of the liquid crystal layer in the liquid crystal panel, and is substantially disposed in parallel with or vertically to a transmission axis of the polarizer or the analyzer.

According to this configuration, with respect to light having the narrow incident angle range with the substrate normal direction as a center, a high contrast ratio can be most effectively obtained. For example, ‘about 45°’, ‘substantially parallel’, and ‘substantially vertical’ described above includes an allowable range of ±5° from the corresponding angle. If the allowable range exceeds ±5°, the contrast ratio cannot be enhanced.

However, in a manufacturing process of the above-described liquid crystal panel, it can be expected that the cell thickness, the pretilt angle of the liquid crystal layer, and the azimuth angle with the pretilt angle of the liquid crystal layer given thereto are deviated from design values. Even when the above-described values are deviated from the design values, in order to advance contrast with the above-described configuration, preferably, the slow axis of the optical compensating plate is movable with respect to the liquid crystal panel. By doing so, the adjustment can be performed on the liquid crystal panel and the optical compensating plate, such that contrast can be further enhanced.

Further, it is preferable that the liquid crystal layer constituting the optical compensating plate is made of nematic liquid crystal.

As for the liquid crystal layer, discotic liquid crystal may also be used. However, when discotic liquid crystal is hybrid-aligned, a sufficiently large in-plane phase retardation is not obtained. On the contrary, when the liquid crystal layer, in which nematic liquid crystal is hybrid-aligned, is used, a large in-plane phase retardation is obtained, as compared with the case in which discotic liquid crystal is used. As the in-plane phase retardation is large, the movement distance of the high-contrast-ratio region can be longer. That is, even when the pretilt angle is large and the high-contrast-ratio region is considerably deviated from the substrate normal direction, at the time of using nematic liquid crystal, the high-contrast-ratio region, which is considerably deviated, can be returned to the substrate normal direction again. Therefore, even when the pretilt angle is large, the tilt direction of the liquid crystal molecules is reliably controlled, such that disclination can be suppressed from occurring. Even when the pretilt angle is increased, as for light in a narrow incident angle range, a high contrast ratio can be obtained. As a result, light leakage due to disclination or the like can be prevented.

Further, it is preferable that optical compensating plates are correspondingly provided between the liquid crystal panel and the polarizer and between the liquid crystal panel and the analyzer, and slow axes of the optical compensating plates are disposed to be substantially perpendicular to each other.

According to this configuration, the high-contrast-ratio region, which is maldistributed on one of the optical compensating plates from the substrate normal direction, can be moved to the substrate normal direction. Further, the high-contrast-ratio region can be expanded on the other optical compensating plate.

### BRIEF DESCRIPTION OF THE DRAWINGS

The invention will be described with reference to the accompanying drawings, wherein like numbers reference like elements, and wherein:

FIG. 1 is a diagram schematically showing essential parts of a projection-type display device according to a first embodiment of the invention;

FIG. 2 is an equivalent circuit diagram of a liquid crystal light valve in the projection-type display device according to the first embodiment of the invention;

FIG. 3 is a plan view showing pixels of the liquid crystal light valve in the first embodiment of the invention;

FIG. 4 is a cross-sectional view taken along the line IV-IV of FIG. 3;

FIG. 5 is an exploded perspective view of the liquid crystal light valve in the first embodiment of the invention;

FIG. 6 is a detailed cross-sectional view of an optical compensating plate of the liquid crystal light valve in the first embodiment of the invention;

FIG. 7 is a diagram showing an intensity distribution of a light source in the projection-type display device according to the first embodiment of the invention;

FIG. 8 is a curve showing equivalent contrast ratios of a liquid crystal light valve according to the related art;

FIG. 9 is a curve showing equivalent contrast ratios of the liquid crystal light valve in the first embodiment of the invention;

FIG. 10 is an exploded perspective view of a liquid crystal light valve according to a second embodiment of the invention; and

FIG. 11 is a curve showing equivalent contrast ratios of a liquid crystal light valve according to a third embodiment of the invention.

### DESCRIPTION OF THE EMBODIMENTS

### First Embodiment

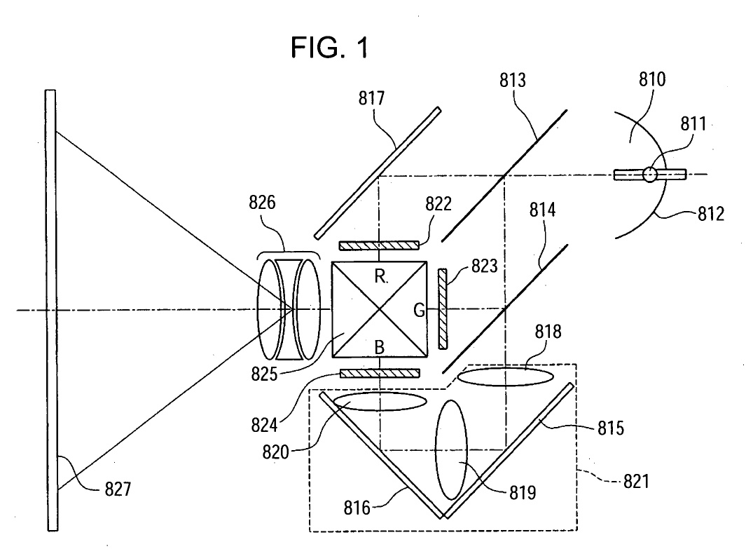

Hereinafter, a first embodiment of the invention will be described with reference to FIGS. 1 to 9.

A projection-type display device of the present embodiment has a liquid crystal light valve (optical modulation unit) that has a liquid crystal panel with a liquid crystal layer interposed between a pair of substrates, optical compensating plates that are respectively disposed outside the liquid crystal panel, and a polarizer and an analyzer that are respectively disposed outside the optical compensating plates. The liquid crystal light valve is an active matrix-type transmissive liquid crystal panel that has a thin film transistor (hereinafter, referred to as TFT) as a switching element.

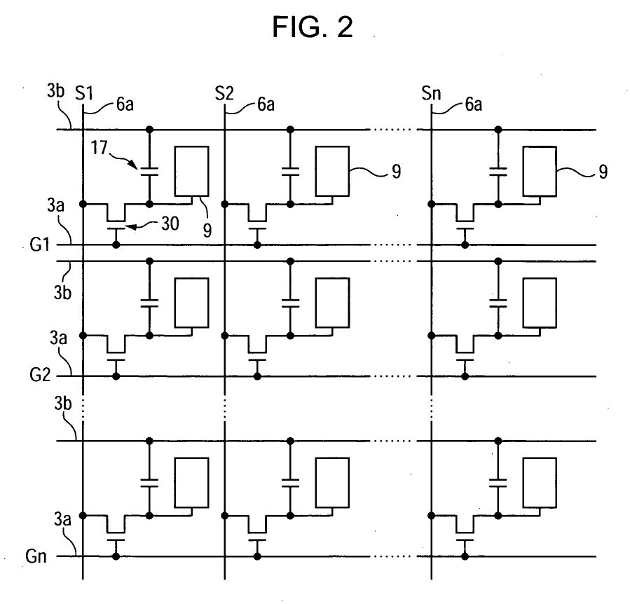

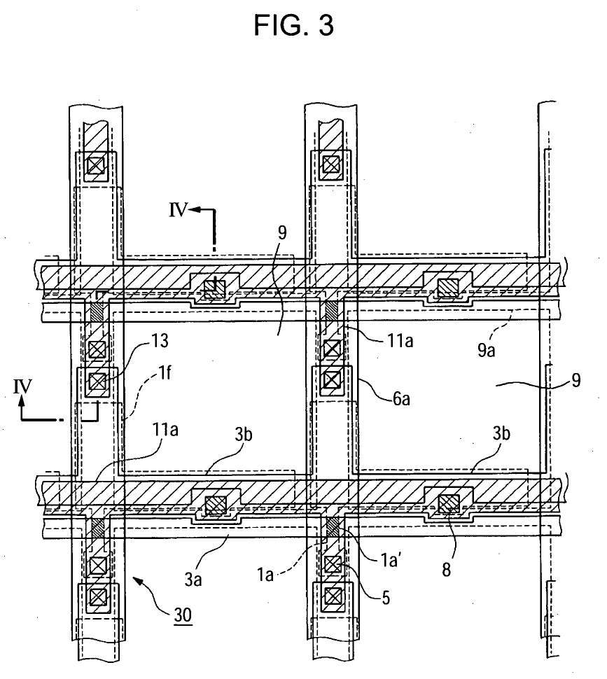

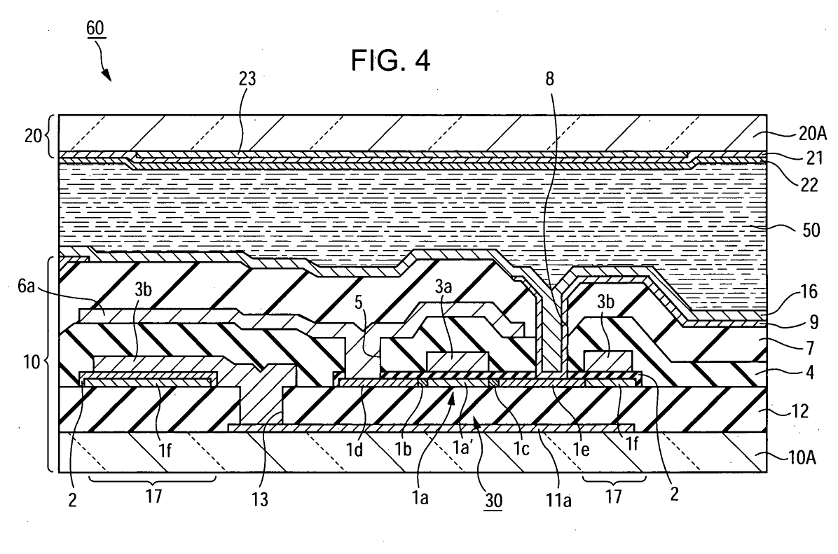

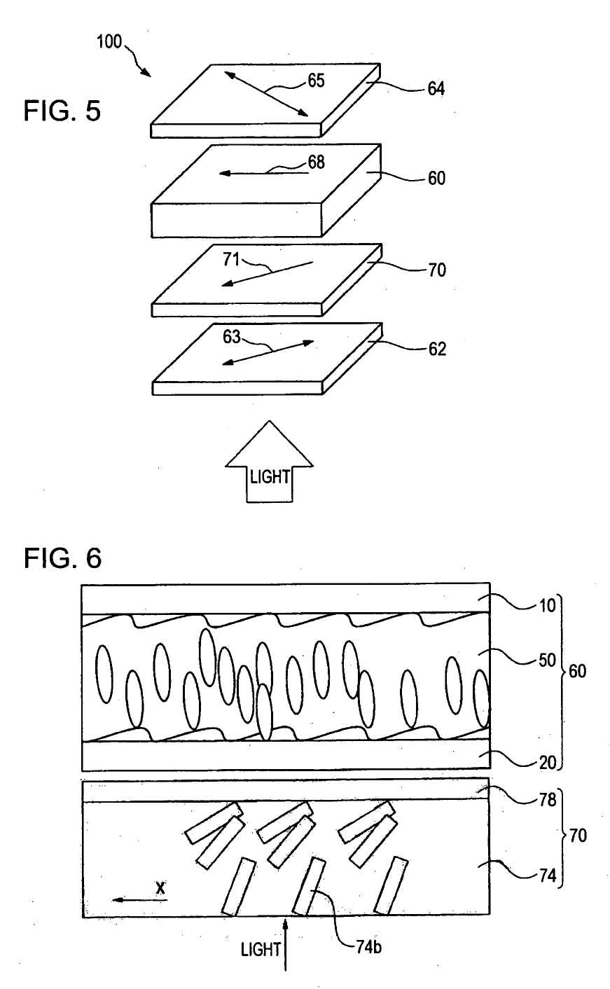

FIG. 1 is a diagram schematically showing essential parts of a projection-type display device. FIG. 2 is an equivalent circuit diagram of a liquid crystal light valve. FIG. 3 is a plan view showing pixels of the liquid crystal light valve. FIG. 4 is a cross-sectional view taken along the line IV-IV of FIG. 3. FIG. 5 is an exploded perspective view of the liquid crystal light valve. FIG. 6 is a detailed cross-sectional view of an optical compensating plate.

Moreover, in the drawings used in the following description, the scale of each member has been adjusted in order to have a recognizable size. Further, in the present specification, as regards to the individual parts of the liquid crystal panel, a liquid crystal layer side is referred to as an inner surface (inside) and an opposite side thereto is referred to as an outer surface (outside). Further, ‘at the time of the application of the non-selection voltage’ and ‘at the time of the application of the selection voltage’ mean ‘when a voltage applied to the liquid crystal layer is around a threshold voltage of liquid crystal’ and ‘when a voltage applied to the liquid crystal layer is sufficiently higher than the threshold voltage of liquid crystal’, respectively.

As shown in FIG. 1, the projection-type display device of the present embodiment has a light source 810 (illumination unit), dichroic mirrors 813 and 814, reflective mirrors 815, 816, and 817, an incident lens 818, a relay lens 819, an emission lens 820, liquid crystal light valves 822, 823, and 824 (light modulation units), a cross dichroic prism 825, and a projection lens 826. The light source 810 has a lamp 811, such as a metal halide lamp or the like, and a reflector 812 that reflects light from the lamp 811.

The dichroic mirror 813 transmits a red light component included in white light from the light source 810 and reflects a blue light component and a green light component. The transmitted red light component is reflected by the reflective mirror 817 and then is incident on the red liquid crystal light valve 822. Further, the green light component reflected by the dichroic mirror 813 is reflected by the dichroic mirror 814 and then is incident on the green liquid crystal light valve 823. In addition, the blue light component reflected by the dichroic mirror 813 passes through the dichroic mirror 814. As for the blue light component, in order to prevent light loss due to a long optical path, a light-guiding unit 821 constituted by a relay lens system having the incident lens 818, the relay lens 819, and the emission lens 820 is provided. The blue light component is incident on the blue liquid crystal light valve 824 via the light-guiding unit 821.

Three color light components modulated by the respective liquid crystal light valves are incident on the cross dichroic prism 825. The cross dichroic prism 825 is formed by bonding four rectangular prisms, and a dielectric multilayered film which reflects the red light component and a dielectric multilayered film which reflects the blue light component are formed in an X shape at the interfaces. The three color light components are synthesized by the dielectric multilayered films, thereby forming light indicating a color image. Synthesized light is projected on a screen 827 through the projection lens 826 serving as a projection optical system, and thus an image is displayed on a magnified scale.

Since light from the lamp 811 in the light source 810 is converted into approximately parallel light by the reflector 812, the incident angle of light-source light with respect to the liquid crystal light valves 822, 823, and 824 is at most about 12°. The projected image is formed from incident light. Here, when a liquid crystal display device described below is used as the liquid crystal light valves 822, 823, and 824, it is possible to enhance the contrast ratio in the normal direction and within a range of small polar angles. Therefore, it is possible to enhance the contrast ratio of the image projected on the screen 827.

First, the liquid crystal light valve according to the first embodiment of the invention will be described.

(Equivalent Circuit Diagram)

FIG. 2 is an equivalent circuit diagram of the liquid crystal panel. Pixel electrodes 9 are formed in a plurality of dots arranged in a matrix shape to constitute an image display region of the transmissive liquid crystal panel. TFT elements 30, serving as switching elements to control the electrical connection to the pixel electrodes 9, are formed at the lateral sides of the pixel electrodes 9. Data lines 6a are electrically connected to the sources of the TFT elements 30. The respective data lines 6a are supplied with image signals S1, S2, . . . , Sn. Moreover, the image signals S1, S2, . . . , Sn may be line-sequentially supplied to the data lines 6a in that order or may be supplied to a plurality of adjacent data lines 6a in groups.

Scanning lines 3a are electrically connected to gates of the TFT elements 30. Scanning signals G1, G2, . . . , Gn are supplied in a pulsed manner to the respective scanning lines 3a with a predetermined timing. Moreover, the scanning signals G1, G2, . . . , Gn are line-sequentially supplied to the scanning lines 3a in that order. The pixel electrodes 9 are electrically connected to drains of the TFT elements 30. Then, if the TFT elements 30 serving as the switching elements are turned on for a constant period using the scanning signals G1, G2, . . . , Gn supplied from the scanning lines 3a, the image signals S1, S2, . . . , Sn supplied from the respective data lines 6a are written to liquid crystal of each pixel with a predetermined timing.

The image signals S1, S2, . . . , Sn of a predetermined level written to liquid crystal are held by liquid crystal capacitors formed between the pixel electrodes 9 and a common electrode to be described below for a constant period. In order to prevent the held image signals S1, S2, . . . , Sn from leaking, storage capacitors 17 are formed between the pixel electrodes 9 and capacitor lines 3b, and are disposed to be parallel to the liquid crystal capacitors. In such a manner, when voltage signals are applied to liquid crystal, the alignment states of the liquid crystal molecules are varied in accordance with the levels of the applied voltage. As a result, light incident on liquid crystal is modulated, such that gray-scale display is realized.

(Planar Structure)

FIG. 3 is a diagram illustrating a planar structure of the liquid crystal panel. In the liquid crystal panel of the present embodiment, the rectangular pixel electrodes 9 (of which outlines are indicated by dotted lines 9a) made of transparent conductive materials, such as indium tin oxide (hereinafter, referred to as ITO), are arranged in a matrix shape on a TFT array substrate. Further, the data lines 6a, the scanning lines 3a, and the capacitor lines 3b are provided along the lateral and longitudinal boundaries of the pixel electrodes 9. In the present embodiment, a region in which each pixel electrode 9 is formed is a dot, and display can be performed in a unit of dots arranged in a matrix shape.

Each TFT element 30 is formed centering on a semiconductor layer 1a made of a polysilicon film or the like. The data line 6a is electrically connected to a source region (to be described below) of the semiconductor layer 1a through a contact hole 5. The pixel electrode 9 is electrically connected to a drain region (to be described below) of the semiconductor layer 1a through a contact hole 8. On the other hand, a channel region 1a′ is formed in a portion facing the scanning line 3a in the semiconductor layer 1a. Moreover, the scanning line 3a serves as a gate electrode in the portion facing the channel region 1a′.

Each capacitor line 3b includes a main line portion (that is, a first region formed along the scanning line 3a in plan view) extending approximately linearly along the scanning line 3a and a protruded portion (that is, a second area extending along the data line 6a in plan view) protruded to a front stage side (upward in the drawing) along the data line 6a from an intersection with the data line 6a. In upwardly hatched regions of FIG. 2, a first light-shielding film 11a is formed. The protruded portion of the capacitor line 3b and the first light-shielding film 11a are electrically connected to each other through a contact hole 13, thereby forming a storage capacitor to be described below.

(Cross-Sectional Structure)

FIG. 4 is a diagram illustrating a cross-sectional structure of the liquid crystal panel and is also a side cross-sectional view taken along the line IV-IV of FIG. 3. As shown in FIG. 4, the liquid crystal panel 60 of the present embodiment primarily includes a TFT array substrate 10, a counter substrate 20 disposed to face the TFT array substrate 10, and a liquid crystal layer 50 interposed between the substrates 10 and 20. The TFT array substrate 10 primarily includes a substrate main body 10A made of a transmissive material, such as glass or quartz, and the TFT elements 30, the pixel electrodes 9, an alignment film 16, or the like formed inside the substrate main body 10A. The counter substrate 20 primarily includes a substrate main body 20A made of a transmissive material, such as glass or quartz, and a common electrode 21, an alignment film 22, or the like formed inside the substrate main body 20A.

A first light-shielding film 11a and a first interlayer insulating film 12 to be described below are formed on the surface of the TFT array substrate 10. The semiconductor layer 1a is formed on the surface of the first interlayer insulating film 12, and the TFT elements 30 are formed from the semiconductor layer 1a. The channel region 1a′, is formed at the portion facing the scanning line 3a in the semiconductor layer 1a, and the source region and the drain region are formed at both sides thereof. Since the TFT element 30 use an LDD (Lightly Doped Drain) structure, heavily doped regions having a relatively high concentration of impurities and lightly doped regions (LDD region) having a relative low concentration of impurities are formed in the source region and the drain region, respectively. That is, a lightly doped source region 1b and a heavily doped source region 1d are formed in the source region, and a LDD region 1c and a heavily doped drain region le are formed in the drain region.

A gate insulating film 2 is formed on the surface of the semiconductor layer 1a. The scanning lines 3a are formed on the surface of the gate insulating film 2, and a part thereof serves as a gate electrode. A second interlayer insulating film 4 is formed on the surfaces of the gate insulating film 2 and the scanning lines 3a. The data lines 6a are formed on the surface of the second interlayer insulating film 4, and each data line 6a is electrically connected to the heavily doped source region Id through the contact hole 5 formed in the second interlayer insulating film 4. A third interlayer insulating film 7 is formed on the surface of the second interlayer insulating film 4 and the data lines 6a. The pixel electrodes 9 are formed on the surface of the third interlayer insulating film 7, and each pixel electrode 9 is electrically connected to the heavily doped drain region le through the contact hole 8 formed in the second interlayer insulating film 4 and the third interlayer insulating film 7. The vertical alignment film 16 made of an inorganic material, such as SiO₂ or the like is formed so as to cover the pixel electrodes 9. The vertical alignment film 16 is formed by obliquely depositing the inorganic material, such as SiO2 or the like, and is imparted with a pretilt such that the tilt direction of the liquid crystal molecules is uniaxially determined according to the deposition direction. By doing so, the alignment direction of the liquid crystal molecules can be controlled at the time of the application of the selection voltage.

Moreover, in the present embodiment, a first storage capacitor electrode 1f is formed to extend from the semiconductor layer 1a. In addition, a dielectric film is formed to extend from the gate insulating film 2, and the capacitor line 3b is disposed on the surface of the dielectric film, thereby forming a second storage capacitor electrode. By doing so, the above-described storage capacitor 17 is constituted.

Further, the first light-shielding film 11a is formed on the surface of the TFT array substrate 10 corresponding to the formation region of the TFT element 30. The first light-shielding film 11a prevents light incident on the liquid crystal panel from entering the channel region 1a′, the lightly doped source region 1b, and the LDD region 1c of the semiconductor layer 1a. Moreover, the first light-shielding film 11a is electrically connected to the capacitor line 3b at the front or rear stage through the contact hole 13 formed in the first interlayer insulating film 12. As a result, the first light-shielding film 11a serves as a third storage capacitor electrode, and a new storage capacitor is formed together with the first storage capacitor electrode 1f with the first interlayer insulating film 12 as a dielectric film.

On the other hand, a second light-shielding film 23 is formed on the surface of the counter substrate 20 corresponding to the formation areas of the data lines 6a, the scanning lines 3a, and the TFT elements 30. The second light-shielding film 23 prevents light incident on the liquid crystal panel from entering the channel region 1a′, the lightly doped source region 1b, and the LDD region 1c of the semiconductor layer 1a. The common electrode 21 made of a conductive material, such as ITO or the like is formed on substantially the entire surface of the counter substrate 20 and the second light-shielding film 23. In addition, the vertical alignment film 22 made of an inorganic material, such as SiO₂ or the like, is formed on the surface of the common electrode 21, like the TFT array substrate 10. The azimuth angle direction of the pretilt of the vertical alignment film 22 is aligned with the azimuth angle direction of the pretilt of the vertical alignment film 16 on the TFT array substrate 10.

The liquid crystal layer 50, which is vertically aligned in an initial stage, is interposed between the TFT array substrate 10 and the counter substrate 20. Liquid crystal showing a negative dielectric anisotropy is vertically aligned at the time of the application of the non-selection voltage, and is horizontally aligned at the time of the application of the selection voltage. Further, with the actions of the vertical alignment films 16 and 22, liquid crystal is uniaxial in a predetermined azimuth angle direction in plan view (in a substrate surface) and has a pretilt of 5° from the substrate normal direction (85° from the substrate surface) in cross-sectional view.

(Polarizing Plate)

FIG. 5 is an exploded perspective view of a liquid crystal light valve 100 according to the first embodiment. The liquid crystal light valve 100 according to the present exemplary embodiment includes the above-described liquid crystal panel 60, an optical compensating plate 70 that is disposed outside the liquid crystal panel 60 (incident side), and a polarizing plate 62 (polarizer) and a polarizing plate 64 (analyzer) that are disposed outside the optical compensating plate 70 (incident side) and outside the liquid crystal panel 60 (emission side), respectively. Each of the optical compensating plate 70 and the polarizing plates 62 and 64 is mounted on a support substrate 78 (see FIG. 6) made of a transmissive material having high thermal conductivity, such as sapphire glass or crystal, and is disposed apart from the liquid crystal panel 60.

As shown in FIG. 5, the polarizing plate 62 is disposed at the light incident side of the liquid crystal panel 60 and the polarizing plate 64 is disposed at the light emission side thereof. The respective polarizing plates 62 and 64 have functions of absorbing linearly polarized light in an absorption axis direction and of transmitting linearly-polarized light in a transmission axis direction. The respective polarizing plates 62 and 64 are disposed such that the absorption axis and the transmission axis are perpendicular to each other (Cross Nicol). The polarizing plates 62 and 64 are disposed such that the azimuth angle direction of the pretilt of the liquid crystal layer 50 (tilt direction of liquid crystal molecules), and the absorption axis of the polarizing plate 62 and the absorption axis of the polarizing plate 64 make an angle of 45°.

When light is incident on the liquid crystal light valve 100 from the downside of the polarizing plate 62, only linearly polarized light aligned with the transmission axis of the polarizing plate 62 passes through the polarizing plate 62. In the liquid crystal panel 60 at the time of the application of the non-selection voltage, the liquid crystal molecules are vertically aligned. For this reason, linearly polarized light incident on the liquid crystal panel 60 is emitted from the liquid crystal panel 60 while keeping the polarization state. Since the polarization direction of linearly polarized light is perpendicular to the transmission axis of the polarizing plate 64, linearly polarized light does not pass through the polarizing plate 64. Therefore, in the liquid crystal panel 60 at the time of the application of the non-selection voltage, black display is performed (normally black mode). Further, in the liquid crystal panel 60 at the time of the application of the selection voltage, the liquid crystal molecules are horizontally aligned. For this reason, linearly polarized light incident on the liquid crystal panel 60 has a phase retardation and is elliptically polarized, and then is emitted from the liquid crystal panel 60. Then, of elliptically polarized light, only a polarized light component in parallel with the transmission axis of the polarizing plate 64 passes through the polarizing plate 64. Therefore, in the liquid crystal panel 60 at the time of the application of the selection voltage, white display is performed.

(Optical Compensating Plate)

In the present embodiment, the optical compensating plate 70 is disposed outside the counter substrate 20 at the light incident side of the liquid crystal panel 60.

FIG. 6 is a side cross-sectional view of the optical compensating plate 70. The optical compensating plate 70 is obtained by providing the alignment film (not shown) on the support substrate 78 made of triacetyl cellulose (TAC) or the like and then by forming a discotic liquid crystal layer 74 made of triphenylene derivative or the like on the alignment film. The alignment film is made of polyvinyl alcohol (PVA) or the like and the surface thereof is subjected to rubbing or the like, thereby controlling the alignment direction of the liquid crystal molecules 74 to parallel with the same imaginary plane. On the other hand, the discotic liquid crystal layer 74 has liquid crystal molecules with a refractive-index ellipsoid having a negative uniaxial property. The liquid crystal molecules have a hybrid alignment structure as shown in FIG. 6. In a hybrid alignment structure, the liquid crystal molecules tilt at angles that gradually differ from each other with respect to the thickness direction. In this example, the in-plane phase retardation of the optical compensating plate 70 is about 13 to 14 nm.

Such a hybrid alignment structure and can be obtained by coating a liquid-crystal discotic compound on the support substrate 78, and by aligning and curing the compound at a predetermined temperature. Moreover, the discotic liquid crystal molecules 74b have a tilt angle of 0° to 15° on the support substrate 78 (on the liquid crystal panel 60), that is, lying down with respect to the substrate surface, and have a tilt angle of 20° to 60° at the opposite side, that is, standing upright with respect to the substrate surface. Moreover, the optical compensating plate 70 may be disposed vice versa. That is, the discotic liquid crystal molecules 74b may stand upright with respect to the substrate surface at the liquid crystal panel 60 side and may lie down with respect to the substrate surface at the opposite side.

The alignment control direction 71 of the discotic liquid crystal molecules 74b (the tilt direction of the liquid crystal molecules) is defined as an X axis direction. The X axis direction is a fast axis direction of the optical compensating plate 70 as viewed in the normal direction thereof (a slow axis direction is perpendicular to the fast axis direction). As such an optical compensating plate 70, specifically, WV film (product name) manufactured by Fuji Photo Film Co., LTD., may be used. As an optical axis arrangement, a slow axis of the optical compensating plate 70 (the same is applied to the fast axis thereof) is disposed at an angle of about 45° with respect to the azimuth angle direction of the pretilt of the liquid crystal layer 50 and also is disposed substantially in parallel or vertically with respect to the transmission axis of the polarizing plate 62 or 64 (the same is applied to the absorption axis thereof).

In the liquid crystal panel 60, when the pretilt is given to vertically aligned liquid crystal constituting the liquid crystal layer 50, the high-contrast-ratio region is maldistributed from the substrate normal direction to the azimuth angle direction of the pretilt. According to the present embodiment, the above-described optical compensating plate 70 is disposed between the liquid crystal panel 60 having such a property and the polarizing plate 62, and thus the high-contrast-ratio region, which is maldistributed from the substrate normal direction, moves to the substrate normal direction. By doing so, light having a narrow incident angle range, which is used for the projection-type display device, centers on the substrate normal direction, and thus a high projection contrast ratio can be obtained.

The inventors have calculated through the simulation how the projection contrast ratio varies in the related art liquid crystal light valve and the liquid crystal light valve according to the invention. Hereinafter, the simulation result will be described.

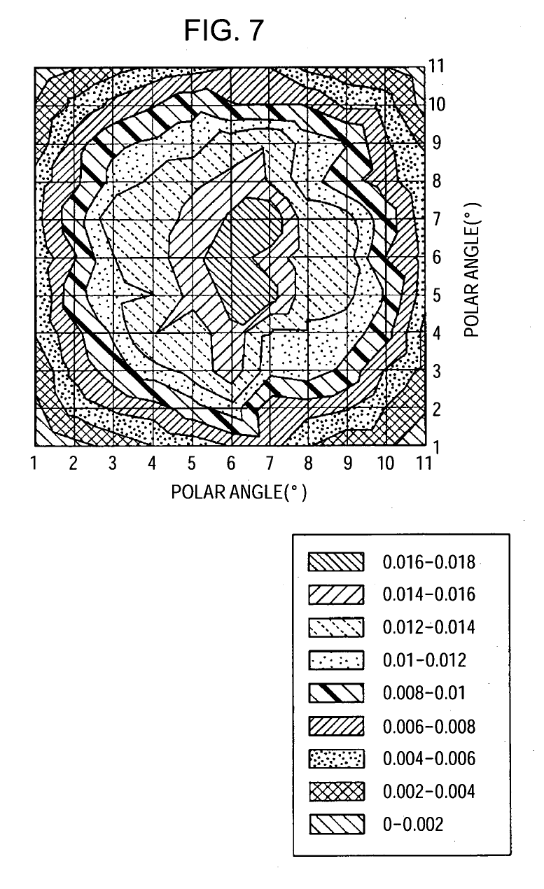

First, the intensity distribution of light emitted from the light source has been examined. FIG. 7 is a diagram showing the intensity distribution of an actual light source. FIG. 7 shows an equivalent luminance curve in a range of from 1° to 11° (cone angle: 10°) when both the vertical axis and the horizontal axis indicate a point of a polar angle of 6° as the substrate normal direction. Here, although the cone angle of less than 10° is shown, luminance in a range of more than 10° is much smaller than that shown in FIG. 7. In particular, it could be seen that light having a maximum intensity of 0.016 to 0.018 (which is a value when the overall amount of light is standardized to 1) is irradiated in a range of from 2° to 3°.

Next, in the related art liquid crystal light valve, that is, the liquid crystal light valve in which the optical compensating plate is not used, a simulation of the projection contrast ratio was performed. The same conditions as those in the present embodiment were applied, except that the optical compensating plate was not used. The pretilt of the vertically aligned liquid crystal layer was set to 5°.

FIG. 8 shows a curve of equivalent contrast ratios through the simulation in the related art liquid crystal light valve. Here, the azimuth angle was in a range of from 0° to 360°, and the polar angle was in a range of from 0° to 20°. Further, the azimuth angle direction of the pretilt of the vertically aligned liquid crystal layer was set to a direction of 45°.

As seen from FIG. 8, the high-contrast-ratio region H having the projection contrast ratio of 900 or more was maldistributed from the center of FIG. 8 (the substrate normal direction) to the direction of the azimuth angle 45° (the azimuth angle direction of the pretilt of the vertically aligned liquid crystal layer).

On the contrary, in the liquid crystal light valve of the present embodiment, that is, the liquid crystal light valve in which the optical compensating plate having hybrid-aligned discotic liquid crystal is used, a simulation of the projection contrast ratio was performed.

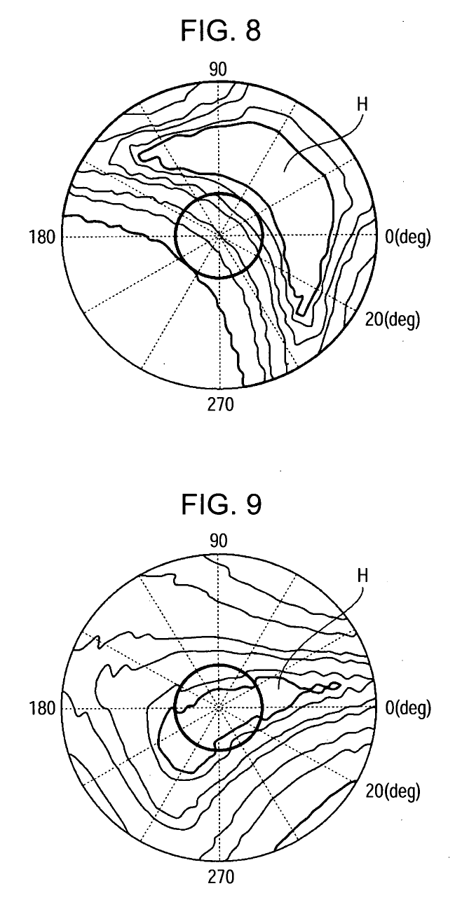

FIG. 9 shows a curve of equivalent contrast ratios obtained through the simulation in the liquid crystal light valve of the present embodiment. Here, the azimuth angle was in a range of from 0° to 360° and the polar angle was in a range of from 0° to 20°. Further, the azimuth angle direction of the pretilt of the vertically aligned liquid crystal layer is set to a direction of 45°.

As seen from FIG. 9, in the liquid crystal light valve of the present embodiment, the high-contrast-ratio region narrows, as compared with the related art liquid crystal light valve of FIG. 8. Further, as regards the difference of the contrast ratios up to a wide angle, the related art liquid crystal light valve is superior. However, in the present embodiment, it could be seen that the high-contrast-ratio region H having the projection contrast ratio of 900 or more is distributed around the center (substrate normal direction) of FIG. 8.

In FIGS. 8 and 9, the range of the cone angle of 5° is shown in a large black circle. With the comparison in this range, while the contrast ratio represents a low value of 100 to 300 in the related art liquid crystal light valve, the contrast ratio represents a high value of 700 to 900 or more in the liquid crystal light valve of the present embodiment. As such, according to the liquid crystal light valve of the present embodiment, when the pretilt is set to a relatively high value of 5°, disclination can be suppressed. Further, even when the incident angle of light-source light peculiar to the projection-type display device narrows, the high projection contrast ratio can be obtained.

### Second Embodiment

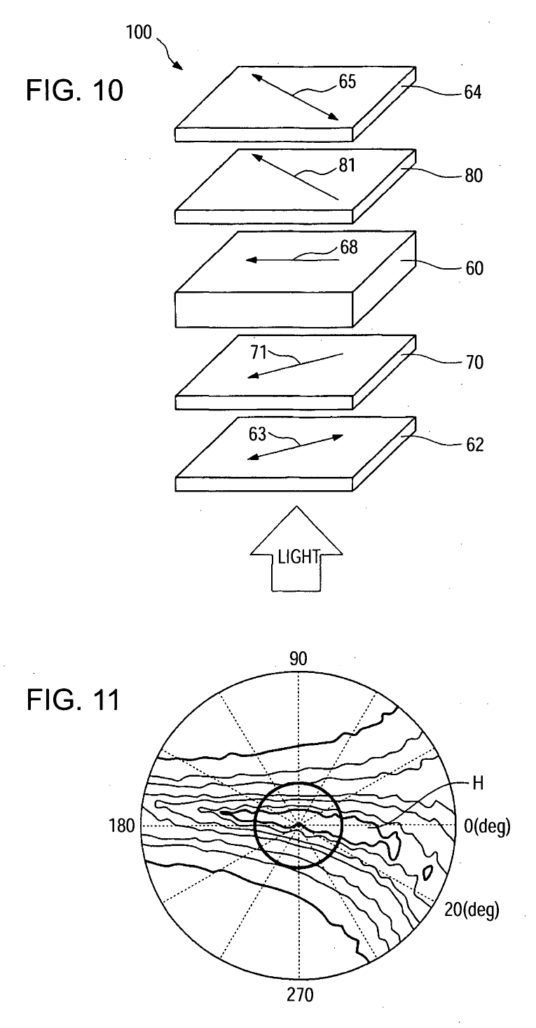

Next, a second embodiment of the invention will be described with reference to FIG. 10.

The basic configuration of a projection-type display device of the present embodiment is the same as that of the first embodiment. The present embodiment is different from the first embodiment in that optical compensating plates are disposed at the light incident side and the light emission side of the liquid crystal panel.

FIG. 10 is an exploded perspective view showing the liquid crystal light valve of the present embodiment. In FIG. 10, the same parts as those in FIG. 5 are represented by the same reference numerals, and the detailed descriptions thereof will be omitted.

As shown in FIG. 10, in the liquid crystal light valve according to the present embodiment, the optical compensating plate 70 is disposed at the light incident side of the liquid crystal panel 60 and an optical compensating plate 80 is disposed at the light emission side thereof. As the optical axis arrangement, the correlation among the azimuth angle direction of the pretilt of the liquid crystal layer of the liquid crystal panel 60, the absorption axis (transmission axis) direction of the polarizing plate 62 or 64, and the slow axis (fast axis) direction of the optical compensating plate 70 at the light incident side is the same as that of the first embodiment. The slow axis (fast axis) of the optical compensating plate 70 and the slow axis (fast axis) of the optical compensating plate 80 are perpendicular to each other. Therefore, the slow axis of the optical compensating plate 80 is disposed at about 45° with respect to the azimuth angle direction of the pretilt of the liquid crystal layer 50 (the same is applied to the fast axis thereof), and also is substantially disposed in parallel or vertically with respect to the transmission axis of the polarizing plate 62 or 64 (the same is applied to the absorption axis thereof).

In the present embodiment, like the first embodiment, as for light in the narrow incident angle range which is used for the projection-type display device and centers on the substrate normal direction, a high projection contrast ratio can be obtained. In addition, in the present embodiment, the two optical compensating plates. 70 and 80 are disposed at the light incident side and the light emission side of the liquid crystal panel 60. Therefore, the high-contrast-ratio region, which is maldistributed by the action of one optical compensating plate, moves the substrate normal direction, and also moves to the substrate normal direction by the action of the other optical compensating plate, such that the area of the high-contrast-ratio region can be expanded. As a result, the projection contrast ratio can be further enhanced.

In the present embodiment, like the first embodiment, the respective optical compensating plates 70 and 80 may be disposed vice versa. Further, though the optical compensating plates 70 and 80 are disposed at the light incident side and the light emission side of the liquid crystal panel 60 by ones in the present embodiment, two optical compensating plates may be disposed only at the light incident side or may be disposed only at the light emission side. In this case, the same advantages as those in the first embodiment can be obtained.

### Third Embodiment

Hereinafter, a third embodiment of the invention will be described with reference to FIG. 11.

The basic configuration of the projection-type display device of the present embodiment is the same as that of the first embodiment. Further, the present embodiment is equal to the first embodiment in that one optical compensating plate is disposed at the light incident side of the liquid crystal panel. Only the configuration of the optical compensating plate itself is different from that of the first embodiment.

In the first embodiment, the optical compensating plate in which discotic liquid crystal is hybrid-aligned is used. On the contrary, in the liquid crystal light valve of the present embodiment, an optical compensating plate in which nematic liquid crystal is hybrid-aligned is used. Like the first embodiment, the optical compensating plate is obtained by providing the alignment film on the support substrate and then forming a nematic liquid crystal layer on the alignment film. The surface of the alignment film is subjected to a rubbing process or the like, thereby controlling the alignment direction of the liquid crystal molecules. On the other hand, the nematic liquid crystal layer has an optical structure in which the tilt angle of the optical axis of a refractive-index ellipsoid having a positive uniaxial property continuously varies in the thickness direction.

Such a hybrid alignment structure can be obtained by coating a nematic liquid crystal compound on the support substrate, and by aligning and curing the compound at a predetermined temperature. Moreover, the nematic liquid crystal compound may be disposed in a state of lying down with respect to the substrate surface at the liquid crystal panel 60 side and in a state of standing upright with respect to the substrate surface at the opposite side thereto. To the contrary, the nematic liquid crystal compound may be disposed in a state of standing upright with respect to the substrate surface at the liquid crystal panel 60 side and in a state of lying down with respect to the substrate surface at the opposite side thereto.

In nematic liquid crystal, like discotic liquid crystal, the alignment control direction (the tilt direction of the liquid crystal molecules) is the fast axis direction (the direction perpendicular thereto is the slow axis). As such an optical compensating plate, specifically, NH film (product name) manufactured by Nippon Oil Corporation may be used. As the optical axis arrangement, the slow axis of the optical compensating plate (the same is applied to the fast axis thereof) is disposed at an angle of about 45° with respect to the azimuth angle direction of the pretilt of the liquid crystal layer and also is disposed substantially in parallel or vertically with respect to the transmission axis of the polarizing plate (the same is applied to the absorption axis thereof).

In the optical compensating plate used in the first embodiment, in which discotic liquid crystal is hybrid-aligned, only the in-plane phase retardation of about 13 to 14 nm is obtained. On the contrary, when the optical compensating plate in which nematic liquid crystal is hybrid-aligned is used, a larger in-plane phase retardation, for example, the phase retardation of about 70 nm to a quarter wave (one hundred and tens nm) is easily obtained, as compared with the case in which discotic liquid crystal is used. As the in-plane phase retardation is larger, the movement distance of the high-contrast-ratio region can be increased. Therefore, if the optical compensating plate of the present embodiment is used, even when the pretilt angle is made larger than that of the first embodiment, as for light in the narrow incident angle range, the high contrast ratio can be obtained. As a result, the tilt direction of the liquid crystal molecules can be controlled further reliably, thereby suppressing disclination from occurring and thus preventing light leakage from occurring due to disclination.

Here, though the pretilt angle is set to 5° from the substrate normal direction in the first embodiment, the inventors have set the pretilt angle of 7° from the substrate normal direction (83° from the substrate surface), which is larger than that in the first embodiment, and then have calculated the projection contrast ratio through a simulation. Hereinafter, the simulation result will be described.

FIG. 11 shows a curve of equivalent contrast ratios through the simulation in the liquid crystal light valve of the present invention. Here, the azimuth angle was in a range of from 0° to 360° and the polar angle was in a range of from 0° to 20°. Further, the azimuth angle direction of the pretilt of the vertically aligned liquid crystal layer is set to a direction of 45°.

As seen from FIG. 11, in the liquid crystal light valve of the present embodiment, the high-contrast-ratio region H narrows, as compared with the related art liquid crystal light valve of FIG. 8. Further, as regards the difference of the contrast ratios up to a wide angle, the related art liquid crystal light valve is superior. However, in the present embodiment, it could be seen that the high-contrast-ratio region H having the projection contrast ratio of 900 or more is distributed around the center (substrate normal direction) of FIG. 8.

In FIG. 11, the range of the cone angle of 50 is shown in a large black circle. With the comparison in this range, while the contrast ratio represents a low value of 100 to 300 in the related art liquid crystal light valve, the contrast ratio represents a high value of 300 to 900 or more in the liquid crystal light valve of the present embodiment. As such, according to the liquid crystal light valve of the present embodiment, when the pretilt is set to a higher value of 7° than that in the first embodiment, disclination can be suppressed more reliably. Further, even when the incident angle of light-source light peculiar to the projection-type display device narrows, the high projection contrast ratio can be obtained, while reliably suppressing disclination.

[Evaluation Results of First to Third Embodiments]

The inventors have compared the projection contrast ratios in the liquid crystal light valves of the first to third embodiments with the projection contrast ratio in the related art liquid crystal light valve, which does not have an optical compensating plate. The results will be described in ‘Table 1’ described below.

The top of ‘Table 1’ represents the ratio of the occupying area of the region having the contrast ratio of 900 or more in the range of the cone angle of 2°. The bottom of ‘Table 1’ represents the calculation values of the contrast ratios at the time of the projection.

TABLE 1

| | | | | NO OPTICAL |
|---|---|---|---|---|
| | ONE DISCOTIC | TWO DISCOTIC | ONE NEMATIC | COMPENSATING PLATE |
| | (FIRST EMBODIMENT) | (SECOND EMBODIMENT) | (THIRD EMBODIMENT) | (RELATED ART) |
| RATIO OF REGION HAVING | 82% | 85% | 70% | 0% |
| CONTRAST RATIO OF 900 | | | | |
| OR MORE | | | | |
| PROJECTION CONTRAST | 1200 | 1500 | 1000 | 400 |
| RATIO | | | | |

As seen from ‘Table 1’, in the related art liquid crystal light valve in which an optical compensating plate is not provided, the ratio of the region having the contrast ratio of 900 or more was 0% and the projection contrast ratio was 400. On the contrary, in the liquid crystal light valve of the first embodiment (in which one discotic-liquid-crystal optical compensating plate is used), the ratio of the region having the contrast ratio of 900 or more was 82% and the projection contrast ratio was 1200. In the liquid crystal light valve of the second embodiment (in which two discotic-liquid-crystal optical compensating plates are used), the ratio of the region having the contrast ratio of 900 or more was 85% and the projection contrast ratio was 1500. Further, in the liquid crystal light valve of the third embodiment (in which one nematic-liquid-crystal optical compensating plate is used), the ratio of the region having the contrast ratio of 900 or more was 70% and the projection contrast ratio was 1000. As such, according to the projection-type display device of the invention, it could be seen that the high projection contrast ratio is obtained.

Moreover, the technical scope of the invention is not limited to the above-described embodiments, but various modifications can be made within the scope without departing from the subject matter of the invention. For example, though the liquid crystal light valve having the TFTs as the switching elements has been exemplified in the embodiments described above, two-terminal elements, such as thin film diodes (TFDs) or the like, may be used as the switching elements. In addition, though the three-plate projection-type display device has been exemplified in the embodiments, the liquid crystal light valve of the invention can be applied to a single-plate projection-type display device.

The entire disclosure of Japanese Patent Applicatoin No. 2004-284003, filed Sep. 29, 2004, is expressly incorporated by reference herein.

What is claimed is:

1. A projection-type display device comprising:
an illumination unit;
a liquid crystal panel for receiving light from the illumination unit at an incident side thereof and transmitting the light through an output side thereof, the liquid crystal panel including a pair of substrates and a liquid crystal layer interposed between the pair of substrates, the liquid crystal layer showing negative dielectric anisotropy and having a pretilt in a predetermined azimuth angle direction;
a polarizer disposed at the light incident side of the liquid crystal panel;
an analyzer disposed at output side of the liquid crystal panel;
an optical compensating plate disposed between the liquid crystal panel and at least one of the polarizer or the analyzer, the optical compensating plate having a hybrid liquid crystal layer with liquid crystal molecules showing negative refractive index anisotropy and wherein the liquid crystal molcules have a tilt direction parallel with the same imaginary plane; and
a projection lens that projects light transmitted through the analyzer.

2. The projection-type display device according to claim 1,
wherein a slow axis of the optical compensating plate is disposed at about 45° with respect to an azimuth angle direction of the pretilt of the liquid crystal layer in the liquid crystal panel, and is substantially disposed in parallel with or vertical to a transmission axis of the polarizer or the analyzer.

3. The projection-type display device according to claim 1,
wherein the liquid crystal layer constituting the optical compensating plate is made of nematic liquid crystal.

4. The projection-type display device according to claim 1,
wherein optical compensating plates are correspondingly provided between the liquid crystal panel and the polarizer and between the liquid crystal panel and the analyzer, and slow axes of the optical compensating plates are disposed to be substantially perpendicular to each other.
